(19) United States
(12) Patent Application Publication
(10) Pub. No.: US 2020/0019229 A1
(43) Pub. Date: Jan. 16, 2020

(54) POWER SEQUENCING BASED ON ACTIVE RAIL

(71) Applicant: QUALCOMM Incorporated, San Diego, CA (US)

(72) Inventors: Raghavendra SRINIVAS, Bangalore (IN); Abhijit JOSHI, Bangalore (IN); Bharat KAVALA, Visakhapatnam (IN); Abinash ROY, San Diego, CA (US)

(21) Appl. No.: 16/033,014

(22) Filed: Jul. 11, 2018

(51) Int. Cl. G06F 1/32; G06F 1/28

(52) U.S. Cl. CPC G06F 1/3287; G06F 1/28; G06F 1/3275; G06F 1/3296

(57) ABSTRACT

Systems and methods for power sequencing include, for an integrated circuit comprising one or more logic instances, one or more power multiplexers to select from at least a first power rail and a second power rail, an active power rail to supply power to the one or more logic instances. One or more sequence multiplexers are used to choose from at least a first power sequence for the first power rail and a second power sequence for the second power rail, an active power sequence. One or more head switches coupled to the one or more logic instances are either turned on, in the active power sequence, to supply power to the one or more logic instances from the active power rail, or turned off, in the active power sequence, the one or more head switches, to power down the one or more logic instances.

### FIELD OF DISCLOSURE

Disclosed aspects are directed to an integrated circuit capable of being powered by at least two power rails. More specifically, exemplary aspects are directed to controlling power sequencing (powering up/powering down) of head switches for the integrated circuit based on an active power rail of the two or more power rails.

### BACKGROUND

Integrated circuit designs, e.g., for processing systems, may include support for several power modes. For instance, functional logic, including memory structures, may be connected to a high power rail (e.g., VDD) in a high power mode or a low power rail (e.g., low VDD) in a low power mode. Power multiplexers (or “muxes”) may be used to facilitate switching the functional logic between the high power rail and the low power rail.

Different functional logic in an integrated circuit may be operated in different power modes. Further, in a respective power mode, various functional logic elements may be fully or partially powered off. For instance, considering a memory system with both peripheral logic and core memory structures, in a power collapse mode, the peripheral logic and the core memory structures may be powered off, while in a memory retention mode (e.g., a sleep mode), the core memory structures may be powered on while the peripheral logic may be powered off.

Waking up or powering down the functional logic as above may be handled using power switches. To avoid an inrush of current, the activation/deactivation (turning on/off) of the power switches coupled to the functional logic are staggered, e.g., in a specific sequence, during the wake-up and power-down processes, respectively. This staggering leads to associated entry and exit latencies for entering and exiting power collapse, respectively.

In conventional implementations, the sequence for staggering the power switches (e.g., head switches) during the entry to and exit from the power collapse is invariant between the different power modes, or in other words, the entry and exit latencies are the same regardless of the active power rail. However, this leads to inefficiencies because the different power rails may have different associated upstream capacitances. The different upstream capacitances may affect the inrush handling needs differently.

To explain, the upstream capacitance of a power rail is a function of the active powered-up or charged area (e.g., standard logic or memory instances) under that power rail. The upstream capacitance of a power rail may be used to shrink the above-described entry/exit times. Thus, adjusting the power sequencing to correspondingly adjust the entry/exit times based on the upstream capacitance of a power rail can lead to efficiencies. However, the conventional implementations fail to exploit the above-noted efficiencies by maintaining the power sequencing (and hence, the entry/exit latencies) to be invariant among the different power rails in the different power modes. Correspondingly, the entry/exit latencies may be unnecessarily high in some of the operating modes in conventional systems.

It is recognized that the longer entry/exit latencies are undesirable. For example, if the software/operating system (OS) responsible for determining which one of multiple cores (e.g., in a multi-core processing environment) to place in a low power mode, detects that long entry/exit latencies would be required for a specific core, then the software/OS may be hesitant to place that core in the low power mode. This is because low power modes with long entry/exit latencies (e.g., an IDLE mode) may be infrequently used, because in these modes, there is typically a lack of a high level of responsiveness; a high level of responsiveness would enable good user experience, snoop performance, service interrupt responsiveness, etc.

Thus, it is desirable to avoid the aforementioned disadvantages, for example, to be able to reduce the entry/exit latencies, which would in turn lead to better power-on-reset and boot-up latencies, better user experience/responsiveness and faster interrupt/snoop responses. Thus, there is a need for solutions which would enable the software/OS to use low power modes more frequently, and thus improve the days of usage (DoU), battery life, etc., without compromising performance.

### SUMMARY

Exemplary aspects of the invention are directed to systems and methods for power sequencing of power switches in an integrated circuit.

For example, an exemplary aspect is directed to method of operating an integrated circuit. The method comprises selecting, from at least a first power rail and a second power rail, an active power rail for supplying power to one or more logic instances of the integrated circuit, and choosing, from at least a first power sequence for the first power rail and a second power sequence for the second power rail, an active power sequence. The method further includes at least one of: turning on, in the active power sequence, one or more head switches coupled to the one or more logic instances, to supply power to the one or more logic instances from the active power rail; or turning off, in the active power sequence, the one or more head switches, to power down the one or more logic instances.

Another exemplary aspect is directed to an apparatus comprising an integrated circuit comprising one or more logic instances. The apparatus includes one or more power multiplexers configured to select from at least a first power rail and a second power rail, an active power rail to supply power to the one or more logic instances, and one or more sequence multiplexers configured to choose from at least a first power sequence for the first power rail and a second power sequence for the second power rail, an active power sequence. The apparatus further includes one or more head switches coupled to the one or more logic instances, wherein the head switches are configured to be, at least one of: turned on, in the active power sequence, to supply power to the one or more logic instances from the active power rail; or turned off, in the active power sequence, the one or more head switches, to power down the one or more logic instances.

Yet another exemplary aspect is directed to an apparatus comprising: means for selecting, from at least a first power rail and a second power rail, an active power rail for supplying power to one or more logic instances of an integrated circuit and means for choosing, from at least a first power sequence for the first power rail and a second power sequence for the second power rail, an active power sequence. The apparatus further comprises at least one of: means for turning on, in the active power sequence, power supply to the one or more logic instances from the active power rail; or means for turning off, in the active power sequence, power supply to the one or more logic instances from the active power rail.

Yet another exemplary aspect is directed to a non-transitory computer-readable storage medium comprising code, which, when executed by a processor, causes the processor to perform operations for controlling power sequencing in an integrated circuit. The non-transitory computer-readable storage medium comprises code for selecting, from at least a first power rail and a second power rail, an active power rail for supplying power to one or more logic instances of the integrated circuit, code for choosing, from at least a first power sequence for the first power rail and a second power sequence for the second power rail, an active power sequence, and at least one of: code for turning on, in the active power sequence, one or more head switches coupled to the one or more logic instances, to supply power to the one or more logic instances from the active power rail; or code for turning off, in the active power sequence, the one or more head switches, to power down the one or more logic instances.

### BRIEF DESCRIPTION OF THE DRAWINGS

The accompanying drawings are presented to aid in the description of aspects of the invention and are provided solely for illustration of the aspects and not limitation thereof.

FIG. 1A illustrates a conventional implementation of a processing system.

FIG. 1B illustrates a timeline for power cycling logic instances of the processing system of FIG. 1A according to conventional techniques.

FIG. 2 illustrates an exemplary apparatus configured for power sequencing based on an active power rail, according to aspects of this disclosure.

FIG. 3 illustrates comparative timelines for power cycling based on an active power rail being a high power rail or a low power rail, based on aspects of power sequencing according to this disclosure.

FIG. 4 illustrates an exemplary method of operating an integrated circuit using power cycling techniques based on an active power rail, according to aspects of this disclosure.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to systems and methods for controlling the power sequencing, e.g., of turning on/off of power switches coupled to functional logic, based on an active rail that the functional logic is connected to. Power muxes, which may appear in sequence with the power switches, and placed between the functional logic and the different power rails, may be configured to couple the functional logic to one of two or more options for the active rail, e.g., based on a selected power mode. For instance, the active rail may be a high power rail in a high power mode (e.g., a high dynamic clock and voltage scaling (DCVS) operation mode, also referred to as a turbo mode) or a low power rail in a low power mode (e.g., a low DCVS operation mode, also referred to as a nominal operating mode). In some aspects, the different active rails may have different upstream capacitances and the power sequencing of the power switches may be selected based on the associated upstream capacitances of the active rails. In exemplary aspects, controlling the power sequencing enables controlling entry/exit latencies in respective power modes. The above aspects will be explained in further detail by referring to the figures below.

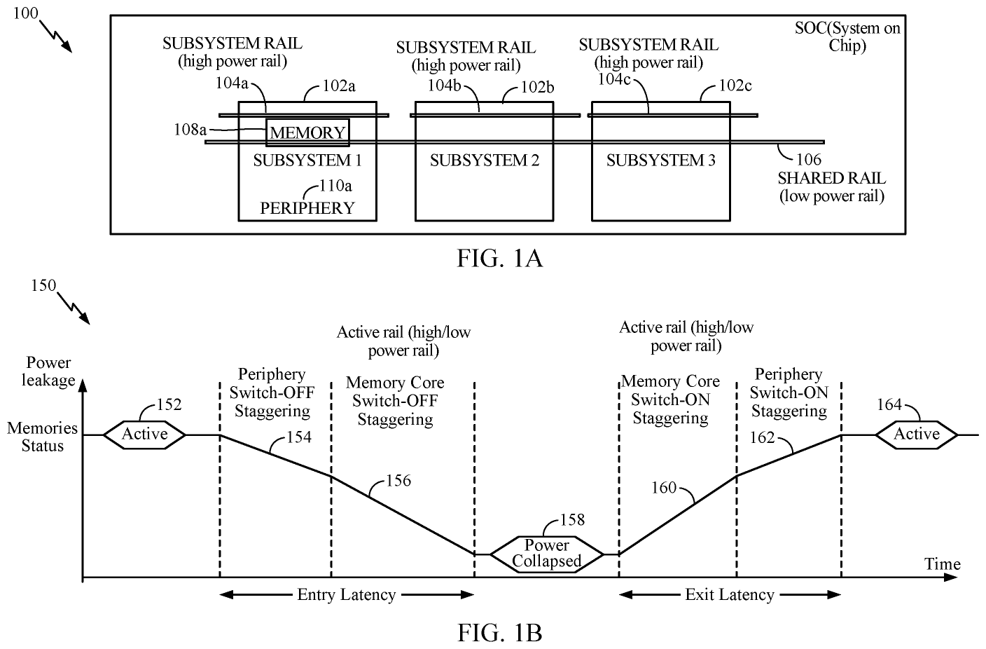

FIGS. 1A-B illustrate conventional implementations of power muxes in integrated circuits. FIG. 1A shows processing system 100 which may be a system on chip (SoC) in an example, with processing system 100 comprising at least the three subsystems identified with reference numerals 102a-c. Each one of the subsystems 102a-c may include a variety of functional logic without loss of generality. The memory instances in subsystems 102a-c, e.g., memory 108a, may be connectable to and configured to be powered by a shared power rail denoted as shared rail 106. Subsystems 102a-c may also have respective dedicated power rails denoted as respective subsystem rails 104a-c to supply power to standard logic cells in the respective subsystems 102a-c.

In some implementations, the dedicated rails or subsystem rails 104a-c which supply power to the standard logic may have more upstream capacitance, because the standard logic cells under the dedicated rails include a bigger part of active area in comparison to the memory structures under shared rail 106 used to power-up the memory bit cell cores for all subsystems 102a-c. In performing a power distribution network (PDN) analysis to determine upstream capacitance, the worst case scenario is considered for shared rail 106, which involves all subsystems 102a-c being in an off condition when the memory core, e.g., memory 108a of a particular subsystem 102a is powered up. In this condition, the available/upstream capacitance on shared rail 106 would be typically lower than that of the respective dedicated rail or subsystem rail 104a of subsystem 102a. The standard logic in subsystem 102a is powered up first, and then memory 108a. This means that in the high power mode or turbo mode, even if the entire processing system 100 goes into a power collapse, the memory cores may be powered-up faster with respective subsystem rails 104a-c. Such a power collapse of processing system 100 may occur several times in the high power mode in order to save power. Accordingly, by powering up memory 108a using subsystem rail 104a, for example, the user responsiveness may be improved.

While in the above-noted implementation, the upstream capacitance of shared rail 106 may be lower than that of respective subsystem rails 104a-c, it is recognized that this is only one example described herein, but not a requirement or limitation. As such, based on different PDN simulations, e.g., for specific technology nodes and cells with respective logic areas and capacitances, the reverse may be true, wherein the upstream capacitance of shared rail 106 may be higher than that of respective subsystem rails 104a-c. Thus, in the aspects described herein, although the operation of some implementations will be described based on assumptions such as the upstream capacitance of shared rail 106 may be lower than that of respective subsystem rails 104a-c, it will be understood that the disclosed aspects may be extended to controlling entry/exit latencies for any combination of power rails with differing upstream capacitances without limitation as to which specific power rail may have lower/higher upstream capacitance in specific modes.

Accordingly, in an implementation wherein subsystem 102a comprises memory 108a and peripheral logic 110a (e.g., comprising read/write circuitry for memory 108a), at least two power modes may be provided, wherein, in a high power/turbo mode, memory 108a may be coupled to the high power subsystem rail 104a, while in a nominal or low power mode, memory 108a may be coupled to the low power shared rail 106. In an example, memory 108a may comprise several memory instances. Although not shown in this view, one or more power muxes (e.g., one power mux per memory instance) may be used in switching the connection of the plurality of memory instances of memory 108a from subsystem rail 104a to shared rail 106, or from shared rail 106 to subsystem rail 104a. While the plurality of memory instances of memory 108a may be connectable through the power muxes to an active rail of the two or more power rails as above, peripheral logic 110a may not be similarly connectable to different power rails, but only connectable to the dedicated subsystem rail 104a, and so power muxes may not be present in the connection of peripheral logic 110a to shared rail 106. To explain further, while the dedicated subsystem rail 104a may power-up the entire subsystem 102a, logic therein such as a central processing unit (CPU) subsystem's logic, may be much larger than memory 108a. Peripheral logic 110a may be part of the CPU subsystem which may be placed around memory 108a, and comprise read-write circuitry, row/column address decoders, etc. Correspondingly, peripheral logic 110a may be powered only by subsystem rail 104a and not shared rail 106.

Additionally, it will be noted that although not shown in this view, power switches, such as head switches (or other means for turning on/off power supply), as known in the art, may be provided to enable powering up or powering down of the functional logic. For peripheral logic 110a, the head switches may be provided in a path between peripheral logic 110a and subsystem rail 104a, such that turning off the head switches will result in powering off the respective peripheral logic 110a. For memory instances in memory 108a, however, the head switches may be provided between the memory instances and the respective power muxes, so that turning off the head switch of a memory instance will result in shutting off power (from whichever active rail a respective power mux is coupled to) to the respective memory instance.

Referring now to FIG. 1B, timeline 150 related to a power cycling process is illustrated for subsystem 102a, wherein timeline 150 is invariant between the above-noted power modes. Thus, in active phase 152, memory 108a may be coupled to one of the two power rails, shared rail 106 or subsystem rail 104a, depending on whether subsystem 102a is in low power/nominal mode or a high power/turbo mode, respectively. The power rail coupled to memory 108a in the selected power mode may simply be referred to as the active rail hereinafter.

From active phase 152, to enter powered down phase 158 wherein subsystem 102a is powered down, the above-noted power sequencing may be used in conventional implementations. Power sequencing refers to turning off the head switches in a staggered sequential manner, rather than simultaneously. The power sequencing avoids an in-rush of current, which may occur if all the functional logic connected to a power rail is powered on or off instantaneously. In timeline 150, the power sequencing for entering powered down phase 158 is shown to involve two components: phase 154, wherein power sequencing of head switches connected to peripheral logic 110a is implemented, and phase 156, wherein power sequencing of head switches connected to memory instances of memory 108a is implemented. The combined duration of phase 154 and 156 to go from active phase 152 to powered down phase 158 is referred to herein as an entry latency (to enter powered down phase 158).

Timeline 150 also shows the counterpart timelines for exiting powered down phase 158 to reach (or return to) active phase 164, with similar power sequencing employed to avoid current in-rush during the powering up of the functional logic of subsystem 102a. Specifically, an exit latency (to exit powered down phase 158) comprises the combined duration of phase 160 for power sequencing head switches connected to memory instances of memory 108a and phase 162 for power sequencing head switches connected to peripheral logic 110a.

As previously noted with reference to FIG. 1A, the upstream capacitance for shared rail 106 may be lower than the upstream capacitance of any one of subsystem rails 104a-c in some implementations. The upstream capacitance of a power rail may advantageously combat the undesirable effects of in-rush current during entry to and exit from the power collapse modes. Thus, by taking advantage of higher upstream capacitance of subsystem rails 104a-c, the entry and exit latencies may be reduced in the high power mode, while continuing to avoid the effects of in-rush currents. Furthermore, there is typically an increased expectation of lower latencies in the high power/turbo modes, which means that reducing the entry and exit latencies in the high power/turbo modes based on the higher upstream capacitance of the high power subsystem's dedicated rail would be particularly advantageous and desirable. However, as seen from timeline 150, there is no difference between the timelines for the different power modes, and specifically entry/exit latencies are the same across the different modes in the conventional implementations.

As previously noted, the power sequencing pattern may be based on PDN simulation result for worst case conditions of both power rails connectable through the power muxes. For the dedicated subsystem rails 104a-c, the worst case is the capacitance of the entire functional logic within the respective subsystem 102a-c (e.g., multiple functional blocks, processing units, peripheral circuitry of memories, etc.) For shared rail 106, the worst case is the capacitance related to only a few always-on memories in the entire processing system 100, which are typically low in number. Thus, for the dedicated subsystem rails 104a-c powering large functional logic, the upstream capacitance may be higher in comparison to the upstream capacitance of shared rail 106 related to only the few always-on memories. However, as noted previously, depending on the specific system under consideration, these worst-case scenarios may be different. Thus, power sequencing patterns may be determined based on PDN simulations during operation or development phases, for example. Based on the implementation, power sequencing pattern may also be flexibly configured such that the pattern may be further tuned based on characterization for worst-case scenarios of different power rails upon production/manufacture.

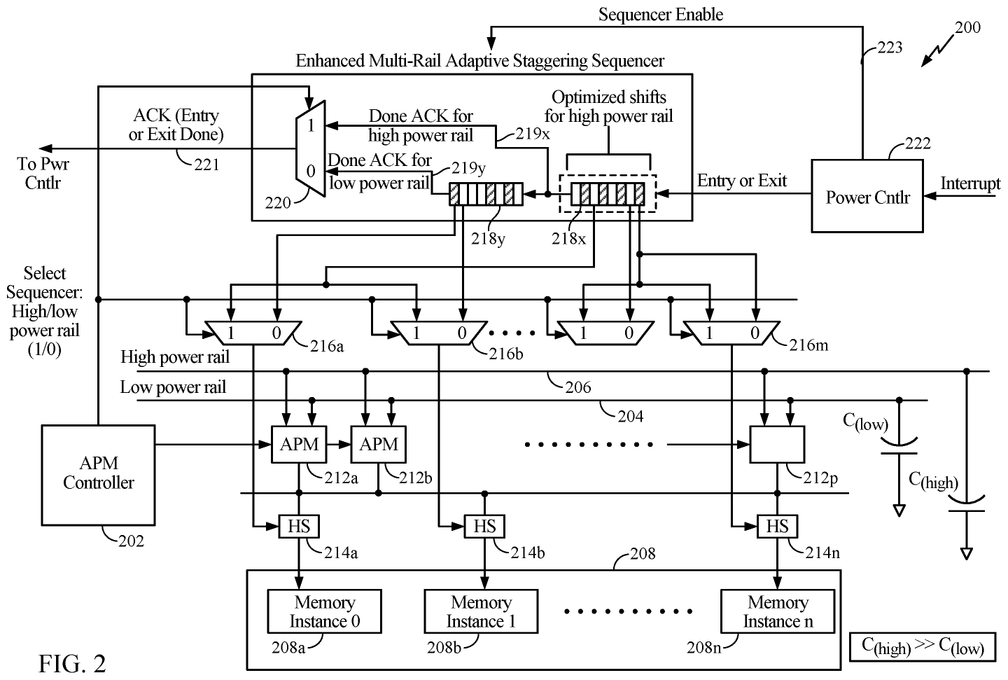

With reference to FIG. 2, an exemplary apparatus 200 comprising integrated circuits/logic configured for controlling the power sequencing based on the power mode/active rail is shown. Although example functional logic will be described for the sake of elucidation of aspects of FIG. 2, it will be understood that the disclosed aspects may be extended to any integrated circuit which may be capable of being powered by multiple power rails.

As shown in FIG. 2, memory 208, comprising multiple memory instances 208a-n, may be powered by at least two power rails, first power rail 204 and second power rail 206. First power rail 204 may be a low power rail, e.g., shared rail 106, while second power rail 206 may be a high power rail such as subsystem rails 104a-c.

One or more power muxes 212a-p (also referred to as array power muxes (APMs)) may be configured to couple memory instances 208a-n to an active power rail chosen between first power rail 204 (e.g., in the low power mode) or second power rail 206 (e.g., in the high power mode). Power mux controller 202 (also referred to as an APM controller) may be configured to control power muxes 212a-p to select the active power rail based, for example, on the power or DCVS mode.

Also shown are power switches, e.g., head switches (HS) 214a-n for turning on or off respective memory instances 208a-n. Although one of head switches 214a-n may connect to a respective one of memory instances 208a-n, as shown, it will be understood that this one-to-one correspondence between head switches 214a-n and memory instances 208a-n is not a requirement, but merely one example. In an active state, wherein memory instances 208a-n are connected to an active power rail (selected by power muxes 212a-p between first power rail 204 or second power rail 206), head switches 214a-n may be in an “on” state (conducting) to enable power supply from the active rail to respective memory instances 208a-n. To enter a powered down state from the active state, head switches 214a-n may be turned “off” in a staggered sequence to disable power to memory instances 208a-n over a duration of time (entry latency), to avoid in-rush currents. Similarly, to enter the active state from the powered down state, head switches 214a-n may be turned on in a staggered sequence to enable power to memory instances 208a-n over another duration of time (exit latency), to avoid in-rush currents. By controlling the sequence in which head switches 214a-n are turned off/on (also referred to as the power sequencing of head switches 214a-n), the entry and exit latencies, respectively, may be controlled.

Sequence muxes 216a-m, as shown in FIG. 2, are configured to control the power sequencing of head switches 214a-n. In one example related to entering a powered down state from an active state, sequence muxes 216a-m may be configured to enable two or more head switches 214a-n to be turned off simultaneously, such that the time taken for all of head switches 214a-n to be turned off may be reduced, thus shrinking the related entry latency in comparison to the time taken for each of head switches 214a-n to be turned off separately in sequence. Similarly, in another example related to exiting the powered down state to enter an active state, sequence muxes 216a-m may also be configured to enable two or more head switches 214a-n to be turned on simultaneously, such that the time taken for all of head switches 214a-n to be turned on may be reduced, thus shrinking the related exit latency in comparison to the time taken for each of head switches 214a-n to be turned on separately in sequence.

In an example implementation shown in FIG. 2, shift registers 218x-y may be used in conjunction with sequence muxes 216a-m to control the entry and exit latencies as discussed above. It is noted that while shift registers 218x-y are discussed in detail herein, any other suitable means for controlling the exit/entry latencies may be used in accordance with this disclosure. In this implementation, shift registers 218x-y may each have a bit-width of two or more bits, with one bit, for example, shifted in periodically, and toggled through the entire bit-width of the shift registers 218x-y. The number of toggles/shifts taken for an input bit to shift registers 218x-y to traverse either the bit-width of shift register 218x alone (or other means for controlling a first latency) or the combined bit-width of both shift registers 218x-y (or other means for controlling a second latency) is used in one example implementation to determine power sequencing of head switches 214a-n.

In an example, the combined bit-width of shift registers 218x-y may correspond to the number of head switches 214a-n. Further, the bit-width of each of shift registers 218x-y may be half the number of head switches 214a-n. In this example, the number of shifts/toggles to traverse the combined bit-width of shift registers 218x-y may control the power sequence in which head switches 214a-n are turned off/on in the low power mode. On the other hand, in a high power mode, two head switches may be controlled by each bit of shift register 218x, such that the number of shifts/toggles to traverse the bit-width of shift register 218x alone may control the power sequence in which head switches 214a-n may be turned on/off. As will be appreciated, by controlling two head switches 214a-n to turn on/off at the same time in this manner for the high power mode, the time taken for all of head switches 214a-n to be turned on/off may be reduced in half in comparison to the low power mode. Thus, in this manner, the corresponding entry/exit latencies of the high power mode may be reduced in half, in comparison to the respective entry/exit latencies in the low power mode.

The bit-widths of shift registers 218x-y may be chosen based on power distribution network (PDN) in-rush analyses during development phase in both power modes to determine optimal entry and exit latencies in each of the power modes. For instance, the bit-widths for each mode may be decided based on how much downstream load/capacitance (e.g., memory instances) can be woken-up at one toggle/shift. Although the bit-widths of shift registers 218x-y have been described as being equal for ease of explanation, it will be understood that any other combination of bit-widths or arrangements of shift registers may be used in alternative aspects based, for example, on desired exit/entry latencies without departing from the scope of this disclosure.

In an aspect, the combined time for a bit to traverse both of shift registers 218x and 218y may be obtained by shifting an input bit through shift register 218x, shifting the bit out from shift register 218x (identified as bit 219x) and in to shift register 218y, e.g., for the low power mode. For the high power mode, bit 219x may not be fed into shift register 218y for power sequencing, since the bit shifting pattern through shift register 218x alone may be used to control power sequencing of head switches 214a-n (keeping in mind, however, that this connection may still be used for an initial entry/exit bit value which may be also be loaded in parallel with shift register 218x, although the respective paths for these have not been specifically illustrated as such details are not particularly germane to the exemplary functionality discussed herein). Sequence muxes 216a-m select between the power sequences as described above depending on the power mode.

Furthermore, an acknowledgement shown as ack 221 that head switches 214a-n have all been turned on/off depending on whether a power down mode is being exited or entered, respectively, can be provided by mux 220. In the high power mode, ack 221 may be asserted based on bit 219x being output from shift register 218x, which indicates that all bits in shift register 218x have been traversed to correspondingly turn on/off head switches 214a-n. In the low power mode which uses a combination of bit shifts through shift registers 218x-y, ack 221 may be selected based on bit 219y output from shift register 218y, which would be output after the combination of bit shifts through shift registers 218x-y have been traversed for power sequencing head switches 214a-n. A power management control (PMC) or power controller 222 may receive an interrupt signal and provide an input bit to be shifted into shift register 218x to enable one or both of shift registers 218x-y to operate in one of the other modes discussed above. In some aspects (e.g., to ensure that upon power mode shifts from high power (or high DCVS mode) to low power (low DCVS) mode, the values in shift registers 218x-y align with the active or power collapsed mode of memory 208) APM controller 202 and power controller 222 may first check that the ACKs from both shift registers 218x-y are the same (i.e., they are both either “1” or “0”) before enabling a new DCVS mode (high or low power mode) or entry to/exit from operation for power collapse respectively. In this manner, APM controller 202 or power controller 222 may ensure that both shift registers 218x-y have the same power switch control value. Upon ensuring that the values are the same, power controller 222 may then provide the above-noted input bit to shift registers 218x-y to indicate entry (e.g., value “0”) or exit (e.g., value “1”) for power collapse. Power controller 222 may then provide the control signal, sequencer enable 223, which would place the above-described power sequencing functions for respective power modes in operation. Similarly, upon ensuring that both shift registers 218x-y are holding the same ACKs, APM controller 202 can proceed with changing the DCVS modes (e.g., from high power/turbo mode to low power/nominal mode).

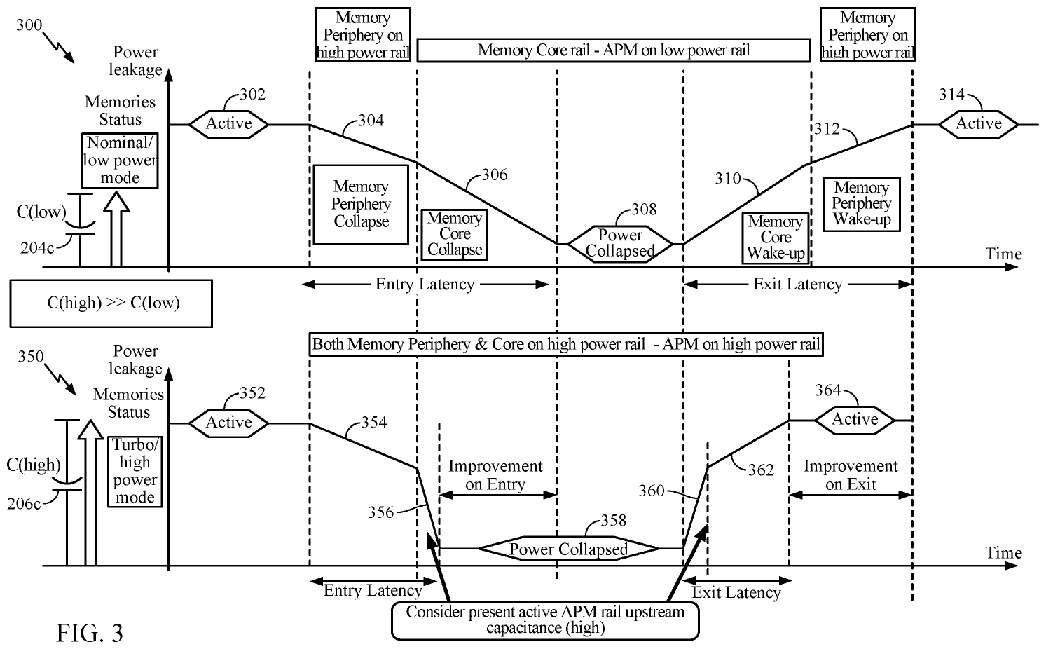

Referring to FIG. 3, timelines 300 and 350 are shown. Timeline 300 corresponds to the low power mode and timeline 350 corresponds to the high power mode discussed with reference to FIG. 2 above. Notably, timeline 300 is similar to timeline 150 discussed with reference to FIG. 1B above, but timeline 350 features reduced entry and exit latencies, as will be further discussed below. The upstream capacitance of low power rail 204 is representatively shown as capacitance 204c and the upstream capacitance of high power rail 206 is representatively shown as capacitance 206c. The upstream capacitance 206c of high power rail 206 is shown to be significantly higher than upstream capacitance 204c of low power rail 204. Correspondingly, the entry/exit latencies of memory 208, when coupled to high power rail 206 in the high power mode may be made smaller than respective entry/exit latencies of memory 208, when coupled to low power rail 204 in the low power mode using shift registers 218x-y and sequence muxes 216a-m for appropriate power sequencing of head switches 214a-n.

Considering timeline 300 in more detail, a power cycling process is illustrated for memory 208 coupled to low power rail 204 selected as the active power rail, through power muxes 212a-p, e.g., in a low power mode. Thus, in active phases 302 and 314, a subsystem comprising memory 208 is coupled to the active power rail, low power rail 204.

From active phase 302, to enter powered down phase 308 wherein the subsystem comprising memory 208 and other peripheral logic are powered down, an entry latency comprising phases 304 and 306 may be involved. Power collapse to enter powered down phase 308, of the peripheral logic, if present, is shown in phase 304, while turning off head switches 214a-n coupled to memory instances 208a-n, one by one in a sequence using the combination of shifts through shift registers 218x-y is shown in phase 306. The combined duration of phases 304 and 306 represent the entry latency into powered down phase 308. Timeline 300 also shows the counterpart timelines for exiting powered down phase 308 to reach (or return to) active phase 314, with similar power sequencing employed to avoid current in-rush during the powering up of the functional logic. Specifically, the exit latency in this mode comprises the combined duration of phase 310 for power sequencing using the combination of patterns in shift registers 218x-y to turn on head switches 214a-n one by one, and phase 312 for power sequencing head switches connected to peripheral logic (not shown).

Referring now to timeline 350, the respective entry and exit latencies for power sequencing head switches 214a-n are shown to be significantly lower than in timeline 300. In more detail, timeline 350 shows a power cycling process for memory 208 coupled to high power rail 206 selected as the active power rail, through power muxes 212a-p, e.g., in the high power or turbo mode.

Thus, in active phases 352 and 364, a subsystem comprising memory 208 and possibly other peripheral logic such as peripheral logic 110a of FIG. 1A but not specifically shown in FIG. 2 are coupled to the active power rail, high power rail 206 in this case.

From active phase 352, to enter powered down phase 358 wherein the subsystem comprising memory 208 and other peripheral logic are powered down, an entry latency comprising phases 354 and 356 may be involved. Power collapse to enter powered down phase 358, of the peripheral logic (if present) is shown in phase 354, whose duration may be the same as phase 304 of timeline 300 shown above. However, turning off head switches 214a-n coupled to memory instances 208a-n, two at a time in a sequence using bit shifts through shift register 218x alone is shown in phase 356. As seen, phase 356 has a shorter duration than phase 306 of timeline 300, demonstrating an improvement in the entry latency.

Timeline 350 also shows improvement in the counterpart timelines for exiting powered down phase 358 to reach (or return to) active phase 364, with similar power sequencing employed to avoid current in-rush during powering up of the functional logic. Specifically, the exit latency in this mode comprises the combined duration of phase 360 and 362, for power sequencing to turn on head switches 214a-n, two at a time based on bit shifts through shift register 218x alone, thus leading to a shorter duration of phase 360 in comparison to counterpart phase 310 of timeline 300. Phase 362 for power sequencing head switches (not shown) connected to peripheral logic may be comparable to that of phase 312 in timeline 300. Since phase 360 is smaller in duration, the exit latency, which is a combination of latencies of phases 360 and 362 in timeline 350, is also smaller in comparison to the exit latency in timeline 300.

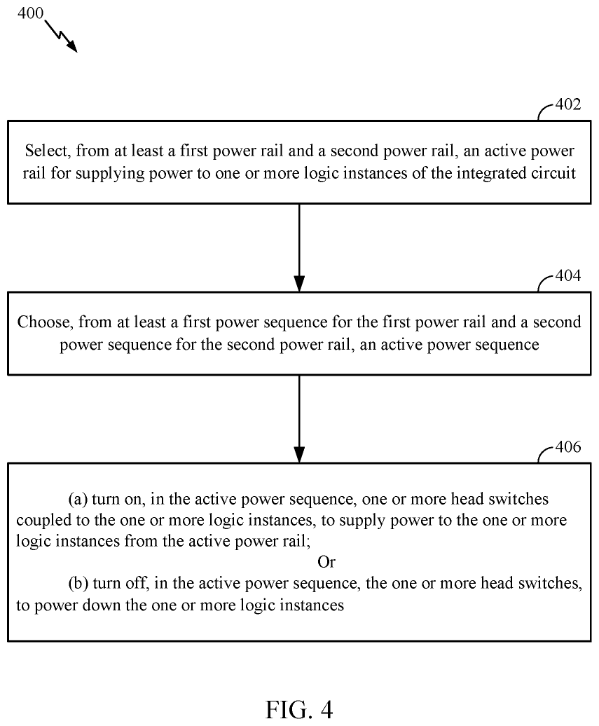

Accordingly, an exemplary aspect for controlling the entry and exit latencies using power sequencing based on the active power rail has been shown. It will be appreciated that exemplary aspects include various methods for performing the processes, functions and/or algorithms disclosed herein. For example, FIG. 4 illustrates a method 400 of operating an integrated circuit (such as apparatus 200).

Block 402 of method 400 may comprise, selecting (e.g., using one or more power muxes 212a-p), from at least a first power rail (e.g., high power rail 206) and a second power rail (e.g., low power rail 204), an active power rail for supplying power to one or more logic instances (e.g., memory instances 208a-n) of the integrated circuit.

Block 404 comprises choosing (e.g., using one or more sequence muxes 216a-m), from at least a first power sequence (e.g., from first shift register 218x) for the first power rail and a second power sequence (e.g., from a combination of first shift register 218x and second shift register 218y) for the second power rail, an active power sequence.

Block 406 comprises at least one of: (a) turning on, in the active power sequence, one or more head switches (e.g., head switches 214a-n) coupled to the one or more logic instances, to supply power to the one or more logic instances from the active power rail (e.g., over the duration of an exit latency corresponding to phase 360 for first power rail 206 or phase 310 for second power rail 204, as shown in FIG. 3); or (b) turning off, in the active power sequence, the one or more head switches, to power down the one or more logic instances (e.g., over the duration of an entry latency corresponding to phase 356 for first power rail 206 or phase 306 for second power rail 204, as shown in FIG. 3).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for power sequencing based on an active power rail. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of operating an integrated circuit, the method comprising:
selecting, from at least a first power rail and a second power rail, an active power rail for supplying power to one or more logic instances of the integrated circuit;
choosing, from at least a first power sequence for the first power rail and a second power sequence for the second power rail, an active power sequence; and
at least one of:
turning on, in the active power sequence, one or more head switches coupled to the one or more logic instances, to supply power to the one or more logic instances from the active power rail; or
turning off, in the active power sequence, the one or more head switches, to power down the one or more logic instances.

2. The method of claim 1, comprising, selecting the active power rail by controlling one or more power multiplexers coupled to the one or more head switches, to select between the first power rail and the second power rail.

3. The method of claim 1, wherein the first power sequence corresponds to a first latency and the second power sequence corresponds to a second latency.

4. The method of claim 3, wherein the first power rail is a high power rail and the second power rail is a low power rail, with the first latency being smaller than the second latency.

5. The method of claim 4, wherein the first power rail has a first upstream capacitance and the second power rail has a second upstream capacitance, with the first upstream capacitance being larger than the second upstream capacitance.

6. The method of claim 4, wherein the first power rail is a dedicated power rail for a first subsystem comprising the one or more logic instances, and the second power rail is a shared power rail between the first subsystem and one or more other subsystems.

7. The method of claim 6, comprising, choosing the active power sequence from the first power sequence and the second power sequence in one or more sequence multiplexers.

8. The method of claim 7, further comprising:
providing the first power sequence to the one or more sequence multiplexers from a first shift register of a first bit-width, wherein the first bit-width corresponds to the first latency; and
providing the second power sequence to the one or more sequence multiplexers from a combination of the first shift register and a second shift register of a second bit-width, wherein a combination of the first bit-width and the second bit-width corresponds to the second latency.

9. The method of claim 8, further comprising selecting the first bit-width and the second bit-width based on the first upstream capacitance and the second upstream capacitance.

10. The method of claim 1, wherein the one or more logic instances comprise respective one or more memory instances, and
wherein turning on the one or more head switches in the active power sequence occurs over a latency corresponding to an exit latency from a powered down mode to an active mode of the one or more memory instances; and
wherein turning off the one or more head switches in the active power sequence occurs over a latency corresponding to an entry latency to the powered down mode from the active mode of the one or more memory instances.

11. An apparatus comprising:
an integrated circuit comprising one or more logic instances;
one or more power multiplexers configured to select from at least a first power rail and a second power rail, an active power rail to supply power to the one or more logic instances;
one or more sequence multiplexers configured to choose from at least a first power sequence for the first power rail and a second power sequence for the second power rail, an active power sequence; and
one or more head switches coupled to the one or more logic instances, wherein the one or more head switches are configured to be, at least one of:
turned on, in the active power sequence, to supply power to the one or more logic instances from the active power rail; or
turned off, in the active power sequence, the one or more head switches, to power down the one or more logic instances.

12. The apparatus of claim 11, wherein the first power sequence corresponds to a first latency and the second power sequence corresponds to a second latency.

13. The apparatus of claim 12, wherein the first power rail is a high power rail and the second power rail is a low power rail, with the first latency being smaller than the second latency.

14. The apparatus of claim 13, wherein the first power rail has a first upstream capacitance and the second power rail has a second upstream capacitance, and wherein the first upstream capacitance is larger than the second upstream capacitance.

15. The apparatus of claim 14, wherein the integrated circuit comprises at least a first subsystem comprising the one or more logic instances and one or more other subsystems, wherein the first power rail is a dedicated power rail for the first subsystem, and the second power rail is a shared power rail between the first subsystem and the one or more other subsystems.

16. The apparatus of claim 15, further comprising:
a first shift register of a first bit-width, configured to the first power sequence to the one or more sequence multiplexers; and
a second shift register of a second bit-width, a combination of the first shift register and the second shift register configured to provide the second power sequence to the one or more sequence multiplexers.

17. The apparatus of claim 16, wherein the first bit-width corresponds to the first latency and the combination of the first bit-width and the second bit-width corresponds to the second latency.

18. The apparatus of claim 17, wherein the first bit-width and the second bit-width are based on the first upstream capacitance and the second upstream capacitance.

19. The apparatus of claim 11, wherein the one or more logic instances comprise respective one or more memory instances, and
wherein the one or more head switches are turned on in the active power sequence over a latency corresponding to an exit latency from a powered down mode to an active mode of the one or more memory instances; and
wherein the one or more head switches are turned off in the active power sequence over a latency corresponding to an entry latency to the powered down mode from the active mode of the one or more memory instances.

20. An apparatus comprising:
means for selecting, from at least a first power rail and a second power rail, an active power rail for supplying power to one or more logic instances of an integrated circuit;
means for choosing, from at least a first power sequence for the first power rail and a second power sequence for the second power rail, an active power sequence; and
at least one of:
means for turning on, in the active power sequence, power supply to the one or more logic instances from the active power rail; or
means for turning off, in the active power sequence, power supply to the one or more logic instances from the active power rail.

21. The apparatus of claim 20, wherein the first power sequence corresponds to a first latency and the second power sequence corresponds to a second latency.

22. The apparatus of claim 21, wherein the first power rail is a high power rail and the second power rail is a low power rail, with the first latency being smaller than the second latency.

23. The apparatus of claim 22, wherein the first power rail has a first upstream capacitance and the second power rail has a second upstream capacitance, with the first upstream capacitance being larger than the second upstream capacitance.

24. The apparatus of claim 22, wherein the first power rail is a dedicated power rail for a first subsystem comprising the one or more logic instances, and the second power rail is a shared power rail between the first subsystem and one or more other subsystems.

25. The apparatus of claim 24, further comprising:
means for providing the first power sequence to one or more sequence multiplexers from means for controlling the first latency; and
means for providing the second power sequence to the one or more sequence multiplexers from means for controlling the second latency.

26. A non-transitory computer-readable storage medium comprising code, which, when executed by a processor, causes the processor to perform operations for controlling power sequencing in an integrated circuit, the non-transitory computer-readable storage medium comprising:
code for selecting, from at least a first power rail and a second power rail, an active power rail for supplying power to one or more logic instances of the integrated circuit;
code for choosing, from at least a first power sequence for the first power rail and a second power sequence for the second power rail, an active power sequence; and
at least one of:
code for turning on, in the active power sequence, one or more head switches coupled to the one or more logic instances, to supply power to the one or more logic instances from the active power rail; or
code for turning off, in the active power sequence, the one or more head switches, to power down the one or more logic instances.

27. The non-transitory computer-readable storage medium of claim 26, comprising, code for selecting the active power rail based on code for controlling one or more power multiplexers coupled to the one or more head switches, to select between the first power rail and the second power rail.

28. The non-transitory computer-readable storage medium of claim 26, wherein the first power sequence corresponds to a first latency and the second power sequence corresponds to a second latency.

29. The non-transitory computer-readable storage medium of claim 28, wherein the first power rail is a high power rail and the second power rail is a low power rail, with the first latency being smaller than the second latency.

30. The non-transitory computer-readable storage medium of claim 29, wherein the first power rail has a first upstream capacitance and the second power rail has a second upstream capacitance, with the first upstream capacitance being larger than the second upstream capacitance.
